(19) United States
(12) Patent Application Publication
(10) Pub. No.: US 2007/0063975 A1
(43) Pub. Date: Mar. 22, 2007

(54) Evaluation method for a control element

(76) Inventors: Oliver Katzenberger, Burglauer (DE); Anton Ruettiger, Wildflecken (DE)

Correspondence Address: MCGRATH, GEISSLER, OLDS & RICHARDSON, PLLC, P.O. BOX 1364, FAIRFAX, VA, 22038-1364, US

(21) Appl. No.: 11/584,512

(22) Filed: Oct. 23, 2006

Related U.S. Application Data
(63) Continuation of application No. PCT/EP05/04360, filed on Apr. 22, 2005.

(30) Foreign Application Priority Data
Apr. 22, 2004 (DE) DE 102004020199.4
Apr. 28, 2004 (DE) DE 102004020949.9

(51) Int. Cl. G09G 5/08

(52) U.S. Cl. 345/161

(57) ABSTRACT

An evaluation method is disclosed for a control element for a motor vehicle, wherein with an actuating element, an optical system comprised of a transmitter and a receiver is interrupted and electrically evaluated by an actuating element, whereby the interruption of the optical systems is evaluated analogous to the deflection of the actuating element.

This nonprovisional application is a continuation of International Application PCT/EP2005/004360, which was filed on Apr. 22, 2005, and which claims priority to German Patent Application Nos. DE 102004020199 and DE 102004020949, which were filed in Germany on Apr. 22, 2004 and Apr. 28, 2004, respectively, and which are all herein incorporated by reference.

### BACKGROUND OF THE INVENTION

1. Field of the Invention

The present invention relates to an evaluation method for a control element for a motor vehicle, wherein via an actuator, an optical system comprised of a transmitter and a receiver is interrupted and electrically evaluated by the actuator.

### SUMMARY OF THE INVENTION

It is an object of the present invention to eliminate mechanical and electrical tolerances of man-machine interface (MMI) control elements, which are designed for high haptic requirements, that is, for more than four operating directions, with touch-free data acquisition, for example, an evaluation of a joystick in eight directions.

The optical systems includes light guides, for example, which are part of a light barrier, as well as an actuating element, that is, a connecting member, which engages in-between the light guides, and analogous to the deflection of the actuating element, controls the amount of light to be passed through, which in this instance is infrared light.

Electronic circuitry comprised of optical components, which form a plurality of light barriers, as well as a micro controller, which effectuates the activation of the light barriers, and which carries out the evaluation of the analogous electrical signals of the light barriers is provided.

Mechanical and optical deviations during production as well as over the lifespan of the product are compensated for by adjustment procedures according to the invention.

The below described evaluation methods are used in analogous optical systems. These systems are comprised of light guides, which form part of a light barrier, as well as an actuating element, which is also referred to as an actuator with a connecting member molded thereto, which engages in-between the light guide elements and, analogous to the deflection of the actuating element, controls and uses the amount of light to be passed through, which preferably is infrared light.

In addition thereto, an electronic circuit comprised of optical components, which form at least two analogous light valves, as well as a micro controller, which effectuates the activation of the light valves, and which carries out the evaluation of the analogous electrical signals of the light valves, is employed.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a flow chart of a calibration procedure according to an embodiment of the present invention;

FIG. 2 is a flow chart of an evaluation procedure according to an embodiment of the present invention;

FIG. 3 is a diagram of a path measurement according to an embodiment of the present invention;

FIG. 4 is a directional chart according to an embodiment of the present invention;

FIG. 5 illustrates a threshold direction; and

FIG. 6 is a flow chart of an adaptation procedure according to an embodiment of the present invention.

### DETAILED DESCRIPTION

To detect switching points in an arrangement as described above, the evaluation methods use a characteristic line, which is determined at an end of the production process by an adjustment procedure, also called calibration.

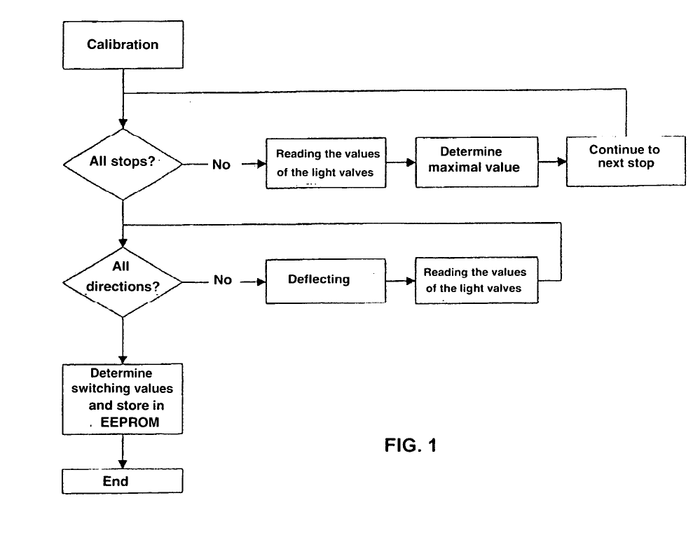

The calibration, with reference to FIG. 1, is thereby described as follows: At the end of the production process, the calibration of the analogous optical system is done at one station. With this procedure, all mechanical and static component tolerances are compensated for.

In step 1, the encoder is moved from stop to stop, and the respective values of the four light valves are registered. Once all stops are recorded, the maximum value of each light valve across all stops is determined. A constant is then applied to the maximum values, thus forming the switching threshold for the detection of a possible push movement.

In a further step, the joystick is successively deflected in all eight directions all the way to the switching point, and the current value of each light valve, which in a preferred embodiment are four optical systems, is recorded. To these values, a constant is also applied. The purpose of the constants is thereby the securing of the switching functions. If the maximum allowed value is exceeded in both steps, this fact is detected and the control unit is rejected.

The calculation of the threshold values for each light valve depends on the evaluation method used. These values are saved in an EEPROM and are used for the evaluation of the optical system, as described in FIG. 1.

The values of the light valves are determined every 10 ms and are made available for evaluation.

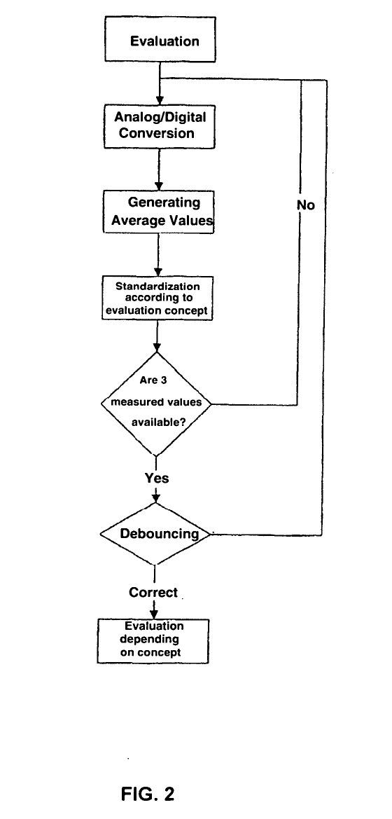

The values of the light valves that are present at the micro controller are subjected to analog-digital (A/D) conversion. The result of the A/D conversion is an average value of four successive A/D conversions per microcontroller entry point. Subsequently, the values of the A/D conversion are standardized and debounced. Only when three successive corresponding values are acquired are these values passed along for evaluation, which is illustrated in more detail in FIG. 2.

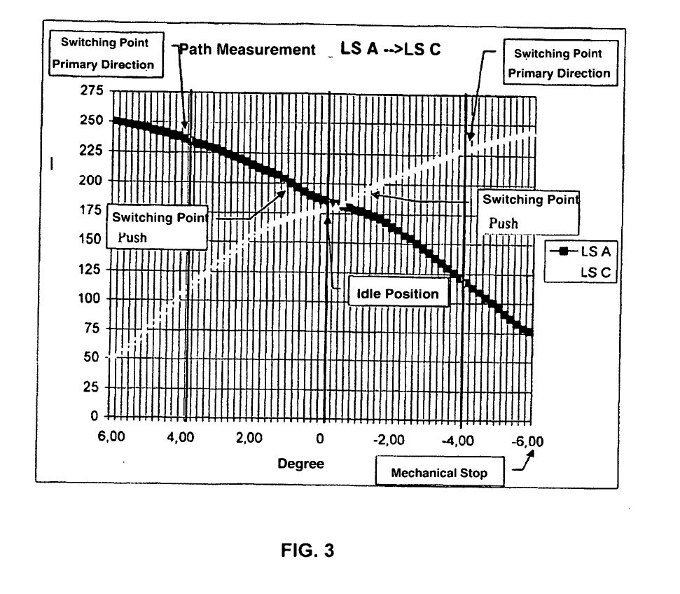

One evaluation method, as shown in FIG. 3, is evaluation by detecting threshold values that were exceeded. When the joystick is deflected from an idle position, threshold values of the characteristic lines associated with the light valves are exceeded until the mechanical limit stop is reached. Exceeding the threshold values provides various conditions, with which the direction of the deflection is detected.

Calibration, the measured values are standardized in the value range of 0 . . . 100, according to: standardized value=(actual value−minimum value)×95/(maximum value−minimum value)+5.

Using the threshold values stored in the EEPROM, a characteristic line is calculated for each light valve.

The primary directions are detected by the following conditions:

Deflection in a Northern direction (this also applies to the other primary directions):
(LSA=5)&(LSB<5)&(LSD<5)) or
((LSA=r)&(LSB=4)) or
((LSA=5)&(LSD=4)) or
((LSA=5)&(LSB=4)&(LSD=4))

For deflection in a North-Eastern direction (the same applies to the other secondary directions):
((LSA=4)&(LSB=4)) or
((LSA=5)&(LSB=5))

The following condition recognizes a possible push function:
((LSA>=3)&(LSB>=3)&(LSC>=3)&(LSD>=3))

During deflection, the mechanical version of the light valves forces a movement into the light valve, and a movement out of the light valve in the opposite light valve. This interrelation is redundant.

If this evaluation does not provide a reasonable result, an evaluation via the values of the complementary light valves can be made in addition, whereby an error correction can be done. Furthermore, the interrelation can be utilized for diagnostic. purposes.

A further evaluation method is the evaluation by determining angle and value. The arrangement of the light valves allows the definition of a Cartesian coordinate system.

During calibration, the maximum and minimum value is registered for each light valve when deflected in eight directions up to the switching point, and is saved in the EEPROM of the controller. The debounced values of the light valves are thereby standardized as follows:
(present value−minimum value)/(maximum value−minimum value)=standardized present value

If the ArcTangens are computed from the current standardized values of the direction-designated light valves

North (LSA/LSD) and (LSA LSB)

Northeast (LSA/LSB)

East (LSA/LSB) and (LSB/LSC)

Southeast (LSB/LSC)

South (LSB/LSC) and (LSC/LSD)

Southwest (LSC/LSD)

West (LSC/LSD) and (LSD/LSA)

Northwest (LSD/LSA)

and the extent from the Pythagoras,
North \sqrt{LSA²+LSD²} and \sqrt{LSA²+LSB²}

Northeast \sqrt{LSA²+LSB²}

East \sqrt{LSA²+LSB²} and \sqrt{LSB²+LSC²}
Southeast \sqrt{LSB²+LSC²}
South \sqrt{LSB²+LSC²} and \sqrt{LSC²+LSD²}
Southwest \sqrt{LSC²+LSD²}
West \sqrt{LSC²+LSD²} and \sqrt{LSA²+LSD²}
Northwest \sqrt{LSA²+LSD²}

the direction and the extend of the deflection can be determined.

A cyclic adaptation is thus performed over the life span, counterbalances, temperature, pollution, and aging. During calibration, the values of the light valves are stored in the EEPROM for the times when the optical system is in an idle position.

By comparing the current analog-digital converted values with the calibrated values, it can be determined if the system is in an idle position:

Case 1: All current values deviate from the calibrated values by the same value. A correction of the light barriers occurs by that deviation if this correction leads to sensible values.

Case 2: The values of opposite light valves deviate in equal measure but in the opposite direction. Optical system is not idle. No adaptation.

Case 3: A single light valve shows a greater deviation than does the rest. In this instance, the switching thresholds of the individual light valves can be corrected within reasonable limits.

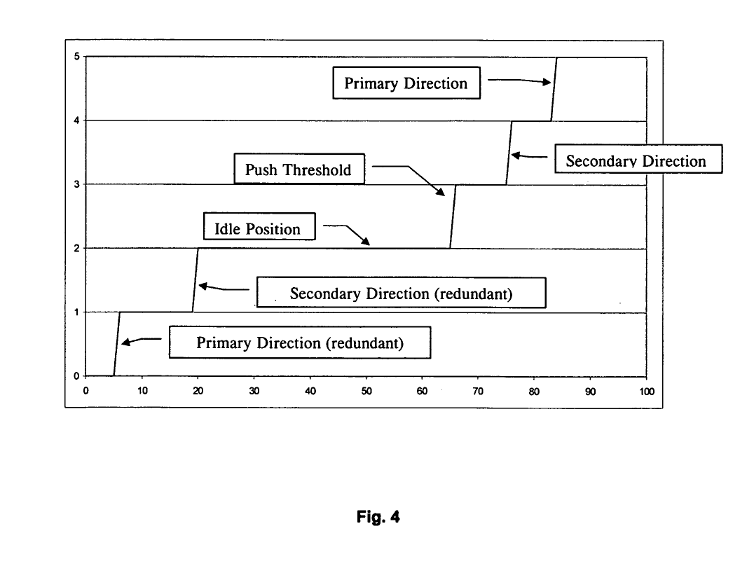

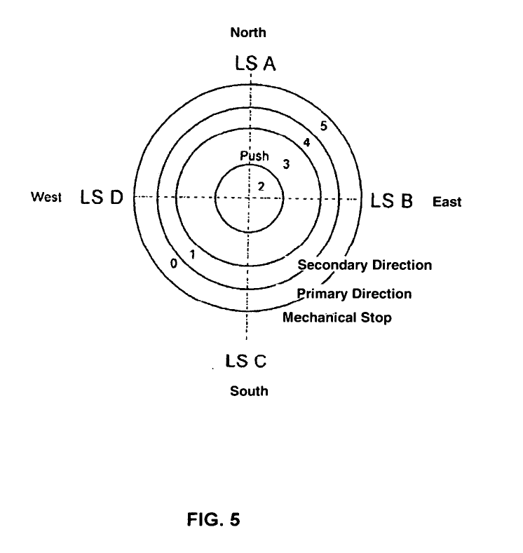

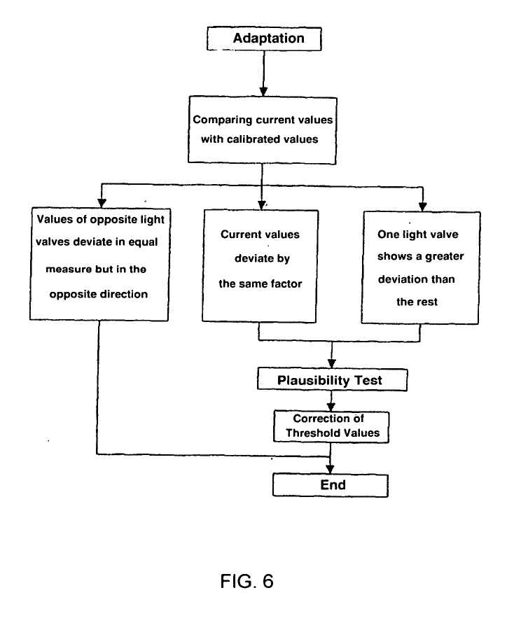

FIGS. 1-6 illustrate the embodiment described above.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An evaluation method for a control element of a motor vehicles, wherein with an actuating element, an optical system comprised of a transmitter and a receiver is interrupted and electrically evaluated by the actuating element, and wherein the interruption of the optical system is evaluated in analogy to the deflection of the actuating element.

2. The method according to claim 1, wherein infrared light is evaluated.

3. The method according to claim 1, wherein at least two measured values or four measured values are acquired.

4. The method according to one claim 1, wherein for the evaluation, an analog measured value is digitalized and an average value is determined.

5. The method according to claim 1, wherein the deflection of the actuating element is carried out by exceeding a threshold value in every direction.

6. The method according to claim 1, wherein the deflection of the actuating element is executed by a defined angle and value.

7. The method according to claim 1, wherein prior to the evaluation, the measured value is bounced, whereby at least three consecutive, identical measured values are acquired.
